(19) United States
(12) Patent Application Publication
(10) Pub. No.: US 2026/0104658 A1
(43) Pub. Date: Apr. 16, 2026

(54) DEVELOPING DEVICE AND IMAGE FORMING APPARATUS INCLUDING THE SAME

(71) Applicant: KYOCERA Document Solutions Inc., Osaka (JP)

(72) Inventors: Minoru WADA, Osaka (JP); Tomohiro TAMAKI, Osaka (JP); Takeru NAGAMOTO, Osaka (JP)

(73) Assignee: KYOCERA Document Solutions Inc., Osaka (JP)

(21) Appl. No.: 19/350,990

(22) Filed: Oct. 6, 2025

(30) Foreign Application Priority Data
Oct. 15, 2024 (JP) 2024-179901

(51) Int. Cl. G03G 15/08

(52) U.S. Cl. CPC G03G 15/0818; G03G 15/0889; G03G 15/0891; G03G 2215/0609; G03G 2215/083; G03G 2215/085

(57) ABSTRACT

A magnet member is non-rotatably secured inside a developing sleeve, and includes a plurality of magnetic poles arranged along a rotation direction of the developing sleeve. The magnetic poles include a main pole facing the image carrying member, and a peeling pole that is disposed downstream of and adjacent to the main pole in the rotation direction of the developing sleeve and that peels off the developer carried on the developer carrying member. A magnetic-flux-density peak-position of the main pole is located below a horizontal line passing through a rotation center of the developing sleeve, and as viewed from an axial direction, an angle that a line extending from the magnetic-flux-density peak-position of the main pole to the rotation center of the developing sleeve forms with respect to the horizontal line passing through the rotation center of the developing sleeve is 40° or larger but 80° or smaller.

### INCORPORATION BY REFERENCE

This application is based on and claims the benefit of priority from Japanese Patent Application No. 2024-179901 filed on October 15, 2024, the contents of which are hereby incorporated by reference.

### BACKGROUND

The present disclosure relates to a developing device and an image forming apparatus including the same.

Conventional developing devices include a development container, a stirring conveyance member, a developer carrying member, and a seal roll, and develop an electrostatic latent image formed on an image carrying member into a toner image. The development container includes a conveyance chamber, and holds therein a two-component developer that includes a carrier and toner. The stirring conveyance member is rotatably supported inside the conveyance chamber, and conveys, while stirring, the developer inside the conveyance chamber.

The developer carrying member is rotatably supported in the development container, and carries on a surface thereof the developer in the conveyance chamber. Both the supply and collection of the developer to and from the developer carrying member are performed inside the conveyance chamber.

The developer carrying member includes a developing sleeve, which is rotatable and cylindrical in shape, and a magnet member. The magnet member is non-rotatably secured inside the developing sleeve, and includes a plurality of magnetic poles arranged along the rotation direction of the developing sleeve. The magnetic poles include a main pole that faces the image carrying member, and a peeling pole. The peeling pole is disposed downstream of and adjacent to the main pole in the rotation direction of the developing sleeve, and peels off the developer carried on the developer carrying member. The seal roll is disposed opposite to the peeling pole, and promotes the peeling of the developer. Thereby, the developer having been peeled off from a developing roller is collected into the conveyance chamber.

However, with the configuration described above, an extra space needs to be prepared for arranging the seal roll, which may consequently lead to an increase in the overall size of the developing device.

An object of the present disclosure is to provide a developing device capable of achieving satisfactory developer peeling performance while suppressing an increase in overall size, and an image forming apparatus including the same.

### SUMMARY

To achieve the object described above, according to a first configuration of the present disclosure, a developing device includes a development container, a first stirring conveyance member, a second stirring conveyance member, and a developer carrying member, and develops an electrostatic latent image having been formed on an image carrying member into a toner image. The development container includes a first conveyance chamber and a second conveyance chamber disposed above the first conveyance chamber with a partition portion therebetween, and holds therein a two-component developer that includes a carrier and toner. The first stirring conveyance member is rotatably supported inside the first conveyance chamber, and conveys, while stirring, the developer inside the first conveyance chamber in a first direction. The second stirring conveyance member is rotatably supported inside the second conveyance chamber so as to be parallel to the first stirring conveyance member, and conveys, while stirring, the developer inside the second conveyance chamber in a second direction that is a direction opposite to the first direction. The developer carrying member is rotatably supported in the development container, and carries, on a surface thereof, the developer in the second conveyance chamber. The developer carrying member includes a developing sleeve, which is rotatable and cylindrical in shape, and a magnet member. The magnet member is non-rotatably secured inside the developing sleeve, and includes a plurality of magnetic poles arranged along a rotation direction of the developing sleeve. The magnetic poles include a main pole that faces the image carrying member, and a peeling pole that is disposed downstream of and adjacent to the main pole in the rotation direction of the developing sleeve and that peels off the developer carried on the developer carrying member. A magnetic-flux-density peak-position of the main pole is located below a horizontal line passing through a rotation center of the developing sleeve, and as viewed from an axial direction, an angle that a line extending from the magnetic-flux-density peak-position of the main pole to the rotation center of the developing sleeve forms with respect to the horizontal line passing through the rotation center of the developing sleeve is 40° or larger but 80° or smaller.

This and other objects of the present disclosure, and the specific benefits obtained according to the present disclosure, will become apparent from the description of embodiments which follows.

### BRIEF DESCRIPTION OF THE DRAWINGS

FIG. 1 is a schematic sectional view showing an overall configuration of an image forming apparatus 100 including developing devices 3a to 3d according to the present disclosure.

FIG. 2 is a side sectional view showing a structure of a stirring portion of a developing device 3a according to one embodiment of the present disclosure.

FIG. 3 is a vertical sectional view obtained by cutting the developing device 3a according to the present disclosure in a direction orthogonal to the longitudinal direction thereof.

FIG. 4 is a vertical sectional view obtained by cutting a developing device 3a according to a modified example of the present disclosure in a direction orthogonal to a longitudinal direction thereof.

### DETAILED DESCRIPTION

### 1. Configuration of Image Forming Apparatus

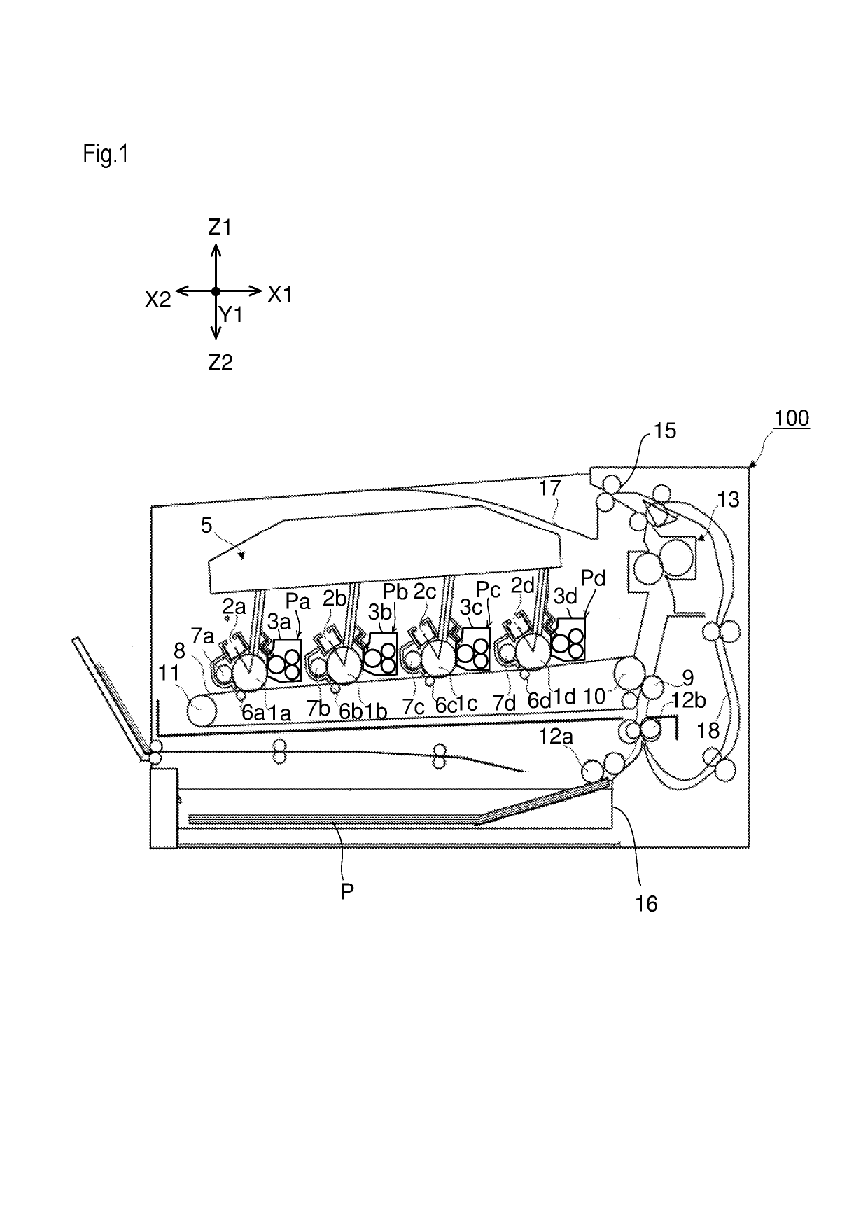

Hereinafter, an embodiment of the present disclosure will be described with reference to the accompanying drawings. FIG. 1 is a schematic sectional view of an image forming apparatus 100 including developing devices 3a to 3d according to the present disclosure. For the convenience of description, the vertical direction in a state where the image forming apparatus 100 is usably installed (the state shown in FIG. 1) is defined as an up-down direction (Z1-Z2 direction). In the image forming apparatus 100, regarding a face thereof located on the side forward of the plane of FIG. 1 as the front face (i.e., the front) of the image forming apparatus 100, a front-rear direction (Y1-Y2 direction) is defined. With reference to the front face of the image forming apparatus 100 in the installed state, a right-left direction (X1-X2 direction) is defined. In the present embodiment, the right-left direction (X1-X2 direction) is orthogonal to both the up-down direction (Z1-Z2 direction) and the front-rear direction (Y1-Y2 direction).

The image forming apparatus 100 is a tandem-type color printer. In the main body of the image forming apparatus 100, four image forming portions Pa, Pb, Pc, and Pd are arranged, in order from Pd to Pa, from an upstream side in a conveyance direction (the right side in FIG. 1). These image forming portions Pa to Pd are provided respectively corresponding to images of four different colors (i.e., yellow, cyan, magenta, and black), and sequentially form images of yellow, cyan, magenta, and black, respectively, through processes of charging, exposure, development, and transfer.

In the image forming portions Pa to Pd, there are arranged photosensitive drums (image carrying members) 1a, 1b, 1c, and 1d,respectively, each carrying thereon a visible image (toner image) of a corresponding one of the different colors. Further, an intermediate transfer belt 8, which rotates in the clockwise direction in FIG. 1, is provided adjacent to the image forming portions Pa to Pd.

When image data is fed in from a host device such as a personal computer, first, the surfaces of the photosensitive drums 1a to 1d are respectively charged uniformly by charging devices 2a to 2d. Subsequently, a scanning device 5 irradiates the photosensitive drums 1a to 1d with light according to the image data, thereby forming electrostatic latent images based on the image data on the photosensitive drums 1a to 1d.

In each of the developing devices 3a to 3d, there is loaded a predetermined amount of two-component developer (hereinafter simply referred to as a developer) including toner of a corresponding one of the four different colors of yellow, cyan, magenta, and black and a magnetic carrier, the developer being replenished from a toner container (unillustrated). The toner in the developer is supplied by each of the developing devices 3a to 3d and electrostatically adheres to a corresponding one of the photosensitive drums 1a to 1d. Thereby, toner images are formed corresponding to the electrostatic latent images having been formed through the exposure by the scanning device 5.

The intermediate transfer belt 8, which is an endless belt, is stretched between a drive roller 10 and a driven roller 11. The drive roller 10 is caused by a motor (unillustrated) to rotate, and thereby drives the intermediate transfer belt 8 to circulate in the clockwise direction in FIG. 1.

The photosensitive drums 1a to 1d are arranged above the intermediate transfer belt 8 in the Z1 direction so as to be adjacent to each other along the conveyance direction. Further, the photosensitive drums 1a to 1d are each in contact with the intermediate transfer belt 8.

Primary transfer rollers 6a to 6d each face a corresponding one of the photosensitive drums 1a to 1d with the intermediate transfer belt 8 therebetween. The primary transfer rollers 6a to 6d are pressed against the intermediate transfer belt 8 to form primary transfer portions together with the photosensitive drums 1a to 1d, respectively. In these primary transfer portions, the toner images are transferred to the intermediate transfer belt 8.

The primary transfer rollers 6a to 6d impart an electric field at a predetermined transfer voltage between the primary transfer rollers 6a to 6d and the photosensitive drums 1a to 1d, respectively, and thereby, the yellow, cyan, magenta, and black toner images respectively on the photosensitive drums 1a to 1d are primarily transferred onto the intermediate transfer belt 8. Toner and other substances remaining on the surfaces of the photosensitive drums 1a to 1d after the primary transfer are removed by cleaning devices 7a to 7d, respectively.

The toner images are transferred onto a transfer sheet P, which is stored in a sheet cassette 16 disposed at a lower part inside the image forming apparatus 100. The transfer sheet P is conveyed, via a sheet feed roller 12a and a registration roller pair 12b, with predetermined timing, to a nip portion (secondary transfer nip portion) between a secondary transfer roller 9 provided adjacent to the intermediate transfer belt 8 and the intermediate transfer belt 8. After having the toner images secondarily transferred thereto, the transfer sheet P is conveyed to a fixing portion 13.

The transfer sheet P having been conveyed to the fixing portion 13 passes through a nip portion between a fixing belt and a pressure roller to be thereby heated and pressed, such that the toner images are fixed to the surface of the transfer sheet P to form a predetermined full-color image. The transfer sheet P having the full color image formed thereon is discharged onto a discharge tray 17 by a discharge roller pair 15 as it is (or after being delivered into a reverse conveyance path 18 to have images formed on both sides thereof).

### 2. Detailed Configuration of Developing Device

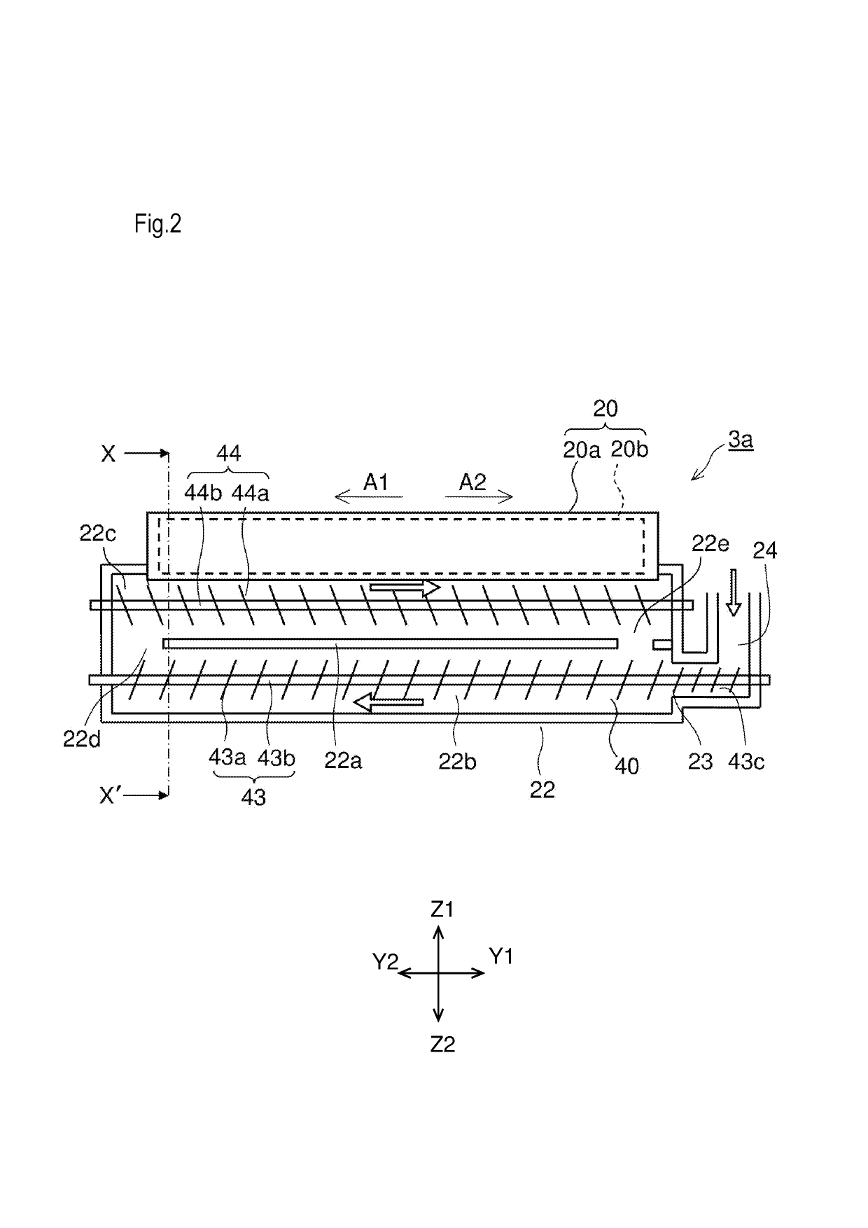

FIG. 2 is a vertical sectional view showing a structure of a stirring portion of a developing device 3a according to one embodiment of the present disclosure incorporated in the image forming apparatus 100. Note that, although described here is the developing device 3a disposed in the image forming portion Pa shown in FIG. 1, the description basically applies also to the configuration of each of the developing devices 3b to 3d respectively disposed in the image forming portions Pb to Pd, and thus overlapping descriptions thereof will be omitted. Moreover, in FIG. 2, for convenience of description, the position of a developing roller 20 is shown shifted above a first conveyance chamber 22b.

As shown in FIG. 2, the developing device 3a includes the developing roller (developer carrying member) 20, a first spiral (first stirring conveyance member) 43, a second spiral (second stirring conveyance member) 44, and a development container 22. The development container 22 includes the first conveyance chamber 22b and a second conveyance chamber 22c that is disposed above (in the Z1 direction) the first conveyance chamber 22b with a partition portion 22a therebetween, and holds therein a two-component developer including a carrier and toner. The development container 22 constitutes the outer casing of the developing device 3a, and has a first communication portion 22d and a second communication portion 22e formed therein.

More specifically, the first conveyance chamber 22b and the second conveyance chamber 22c are loaded with a two-component developer including a magnetic carrier and toner. Further, the development container 22 rotatably holds the first spiral 43, the second spiral 44, and the developing roller 20.

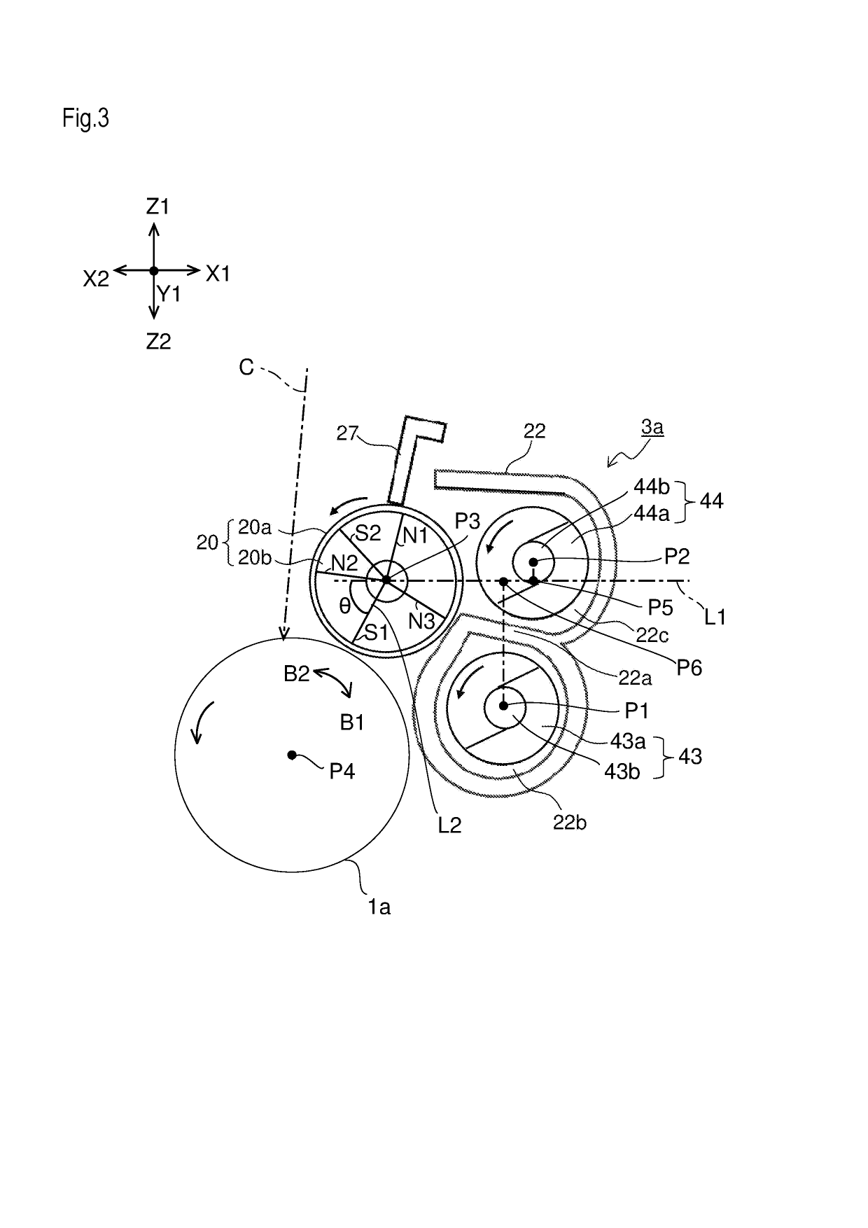

The partition portion 22a extends in the longitudinal direction of the development container 22, separating the first conveyance chamber 22b and the second conveyance chamber 22c, such that they are arranged in parallel in the up-down (Z1-Z2) direction (see FIG. 3). The first communication portion 22d and the second communication portion 22e are respectively formed on one and the other sides of the partition portion 22a in the longitudinal direction thereof (i.e., an A1-direction downstream side and an A2-direction downstream side). The first communication portion 22d allows communication between downstream-side end parts of the first conveyance chamber 22b and the second conveyance chamber 22c in the A1 direction (first direction). The second communication portion 22e allows communication between downstream-side end parts of the first conveyance chamber 22b and the second conveyance chamber 22c in the A2 direction (second direction). The developer circulates through the first conveyance chamber 22b, the first communication portion 22d, the second conveyance chamber 22c, and the second communication portion 22e.

The first spiral 43 is rotatably supported inside the first conveyance chamber 22b, and conveys, while stirring, the developer inside the first conveyance chamber 22b in the A1 direction (first direction). The first spiral 43 includes a rotation shaft 43b, which is rotatably supported in the development container 22, and a first helical blade 43a. The first helical blade 43a, which is integrally provided on the rotation shaft 43b, is formed in a helical shape with a constant pitch along the axial direction of the rotation shaft 43b. The first spiral 43 is caused by an unillustrated drive mechanism to rotate in a predetermined direction (counterclockwise direction in FIG. 3). The first helical blade 43a rotates in the predetermined direction, and thereby conveys, while stirring, the developer inside the first conveyance chamber 22b in the A1 direction (toward one side in the axial direction of the developing roller 20).

Further, in the end face of the first conveyance chamber 22b in the A2 direction, a toner replenishment port 23 is formed for replenishing the development container 22 with the toner therethrough. Connected to the toner replenishment port 23 is a toner replenishment path 24 which is also connected to the toner container (unillustrated). The rotation shaft 43b is disposed so as to pass through the toner replenishment port 23 to extend into the toner replenishment path 24. Part of the rotation shaft 43b is located inside the toner replenishment path 24, and on that part of the rotation shaft 43b, a replenishment blade 43c is integrally formed in a helical shape with a predetermined pitch in the axial direction of the rotation shaft 43b. The replenishment blade 43c is formed of a helically-shaped blade oriented in the same direction (in the same phase) as the first helical blade 43a. The replenishment blade 43c is formed with a smaller pitch and a smaller diameter than the first helical blade 43a.

The second spiral 44 is rotatably supported inside the second conveyance chamber 22c so as to be parallel to the first spiral 43, and conveys, while stirring, the developer inside the second conveyance chamber 22c in the A2 direction (second direction), which is a direction opposite to the A1 direction (first direction). The second spiral 44 includes a rotation shaft 44b, which is rotatably supported in the development container 22 so as to be parallel to the rotation shaft 43b, and a second helical blade 44a. The second helical blade 44a, which is integrally provided on the rotation shaft 44b, is helically formed of a blade oriented in a direction opposite (in the phase opposite) to the first helical blade 43a. The second spiral 44 is caused by an unillustrated drive mechanism to rotate in a predetermined direction (counterclockwise direction in FIG. 3). The second helical blade 44a rotates in the same direction as the first helical blade 43a, and thereby conveys, while stirring, the developer inside the second conveyance chamber 22c in the A2 direction (direction opposite to the A1 direction) onto the developing roller 20.

The first spiral 43 and the second spiral 44 stir the developer to thereby cause the toner in the developer to be charged to a predetermined level. Thereby, the toner is held on the carrier.

When the first spiral 43 and the second spiral 44 rotate, the developer is conveyed through one (the first communication portion 22d) of the communication portions formed in the partition portion 22a to the second spiral 44. The developer is further conveyed through the other one (the second communication portion 22e) of the communication portions to the first spiral 43, thereby circulating through the first conveyance chamber 22b and the second conveyance chamber 22c. Then, the developer is supplied from the second spiral 44 onto the developing roller 20, thereby forming a magnetic brush on the developing roller 20.

The developing roller 20 (developer carrying member) is rotatably supported in the development container 22, and carries the developer inside the second conveyance chamber 22c on a surface thereof. The developing roller 20 (developer carrying member) includes a developing sleeve 20a, which is rotatable and cylindrical in shape, and a magnet member 20b. The magnet member 20b is non-rotatably secured inside the developing sleeve 20a, and includes a plurality of magnetic poles arranged along a rotation direction of the developing sleeve 20a. The developing sleeve 20a is caused by an unillustrated drive mechanism to rotate in an arrow direction (counterclockwise direction) in FIG. 3. Further, to the developing sleeve 20a, a development voltage resulting from superposing an alternating-current voltage on a direct-current voltage is applied. A detailed description will be given later regarding the configuration of the developing roller 20 (developer carrying member).

The developer inside the first conveyance chamber 22b is conveyed, while being stirred, by the first spiral 43 in the A1 direction (toward the first communication portion 22d side), and gradually accumulates at one side in the first conveyance chamber 22b. At the one side of the first conveyance chamber 22b, the developer is pushed by the incoming developer and is lifted up into the second conveyance chamber 22c via the first communication portion 22d. The developer inside the second conveyance chamber 22c is conveyed, while being stirred, by the second spiral 44 in the A2 direction (toward the second communication portion 22e side) to be supplied to the developing roller 20. The developer having been conveyed to the other side of the second conveyance chamber 22c falls into the first conveyance chamber 22b through the second communication portion 22e.

### 3. Detailed Configuration of Magnet Member

FIG. 3 is a vertical sectional view (sectional view taken along line XX' in FIG. 2) obtained by cutting the developing device 3a according to the present embodiment in a direction orthogonal to the longitudinal direction thereof. A regulation blade 27 is attached to the development container 22. More specifically, the regulation blade 27 is attached along the longitudinal direction (a direction perpendicular to the plane of FIG. 3) of the developing roller 20.

Between the edge of the regulation blade 27 and the outer circumferential surface of the developing roller 20, a small gap (a regulation gap) is provided to form a regulation portion. By the developing sleeve 20a rotating to cause the developer (magnetic brush) to pass through the regulation portion, the thickness of the developer layer carried on the surface of the developing roller 20 is regulated. In the present embodiment, used as the regulation blade 27 is a magnetic blade made of stainless steel (SUS430).

The developing roller 20 includes the magnet member 20b including a plurality of magnetic poles N1, S2, N2, S1, and N3 arranged along the rotation direction (counterclockwise direction in FIG. 3) of the developing sleeve 20a. The magnetic poles N1, S2, N2, S1, and N3 indicate magnetic-flux-density peak-positions of the magnet member 20b in the circumferential direction thereof. In the present embodiment, the magnet member 20b is constituted of five poles including a regulation pole (pump-up pole) N1, conveyance poles N2 and S2, a main pole S1, and a peeling pole N3. The regulation pole (pump-up pole) N1 is disposed in a region (regulation portion) facing the regulation blade 27. In the present embodiment, the regulation pole N1 functions also as a pump-up pole for pumping up the developer onto the developing roller 20.

The main pole S1 faces the photosensitive drum (image carrying member) 1a. More specifically, the main pole S1 is disposed in a region (developing region) facing the photosensitive drum (image carrying member) 1a. The peeling pole N3 is disposed downstream of and adjacent to the main pole S1 in the rotation direction of the developing sleeve 20a, and peels off the developer carried on the developing roller (developer carrying member) 20.

The conveyance poles N2 and S2 are disposed between the regulation pole (pump-up pole) N1 and the main pole S1. In the present embodiment, the magnet member 20b has a five-pole configuration. When a driving force is fed to the developing device 3a, the developing sleeve 20a rotates, but the magnet member 20b does not.

The developing device 3a supplies the developer from the second spiral 44 inside the second conveyance chamber 22c to the developing roller 20. Then, the developer having passed through the developing region while having the toner therein consumed for development is collected into the second conveyance chamber 22c, where the second spiral 44 is disposed.

More specifically, due to generation of a magnetic field in a direction of mutual attraction between the regulation pole N1 and the regulation blade 27 of the magnet member 20b, particles of the developer chain between the regulation blade 27 and the developing roller 20 to form a magnetic brush. The magnetic brush passes under the regulation blade 27 (regulation portion), thereby having its layer thickness regulated to a predetermined height.

When the developing sleeve 20a further rotates in the counterclockwise direction, the conveyance poles S2 and N2 impart, to the magnetic brush, a magnetic field in a direction along the outer circumferential surface of the developing sleeve 20a. Further, the main pole S1 imparts to the magnetic brush a magnetic field in a direction of mutual attraction with the photosensitive drum 1a. As a result, the magnetic brush contacts the surface of the photosensitive drum 1a to develop the electrostatic latent image. On the other hand, toner that has not been consumed in the development is collected by the magnetic brush formed on the developing sleeve 20a.

When the developing sleeve 20a rotates further in the counterclockwise direction, the magnetic brush is removed from the developing roller 20 due to the repulsive magnetic field between the peeling pole N3 and the regulation pole (the pump-up pole) N1 so as to be collected into the second conveyance chamber 22c. The collected toner is conveyed, while being stirred, by the second spiral 44. A magnetic brush is formed again on the developing sleeve 20a due to the magnetic field of the regulation pole (pump-up pole) N1.

In the developing device 3a according to the present embodiment, the second conveyance chamber 22c is disposed above the first conveyance chamber 22b in the Z1 direction.

That is, the first conveyance chamber 22b and the second conveyance chamber 22c are arranged in the up-down direction. With this arrangement, the developing device 3a can be made compact in the horizontal (X1-X2) direction. In the image forming apparatus 100, the four developing devices 3a to 3d are arranged in the horizontal (X1-X2) direction, and thus the compactness of the developing devices 3a to 3d in the horizontal (X1-X2) direction helps make the image forming apparatus 100 compact in the horizontal (X1-X2) direction.

Further, the developing roller 20 has a rotation center P3 that is disposed, in the up-down (Z1-Z2) direction, between a center P2 of the rotation shaft 44b of the second spiral 44 and a center P1 of the rotation shaft 43b of the first spiral 43. By arranging the rotation center P3 of the developing roller 20 below the center P2 of the rotation shaft 44b of the second spiral 44 in the Z2 direction, the developing device 3a can be made compact also in the up-down direction.

Further, the position of the developing roller 20 can be changed with respect to the photosensitive drum 1a in a circumferential direction of the photosensitive drum 1a. Here, as viewed from the axial direction, by moving the developing roller 20 with respect to the photosensitive drum 1a in a clockwise direction B1, an angle θ formed by a line L2 with respect to a line L1 is made smaller. On the other hand, as viewed from the axial direction, by moving the developing roller 20 with respect to the photosensitive drum 1a in a counterclockwise direction B2, the angle θ formed by the line L2 with respect to the line L1 is made larger. The line L1 is a horizontal (X1-X2) line that passes through the rotation center P3 of the developing sleeve 20a. The line L2 is a line extending from the main pole S1 to the rotation center P3 of the developing sleeve 20a.

In the present embodiment, the angle θ formed by the line L2 with respect to the line L1 is preferably 40° or larger but 80° or smaller. In a case where the developing roller 20 is moved with respect to the photosensitive drum 1a in the circumferential direction such that the angle θ formed by the line L2 with respect to the line L1 is 40°or larger, the developing roller 20 is disposed (on a B2 side) close to directly above a rotation center P4 of the photosensitive drum 1a.

This arrangement helps make the developing device 3a compact in the horizontal (X1-X2) direction. Furthermore, space can be secured for placing a sensor to detect toner concentration. Here, the sensor for detecting toner concentration is preferably disposed between the intermediate transfer belt 8 and an outer wall of the first conveyance chamber 22b so as to be close to directly below the outer wall of the first conveyance chamber 22b.

On the other hand, in a case where the developing roller 20 is moved with respect to the photosensitive drum 1a in the circumferential direction such that the angle θ formed by the line L2 with respect to the line L1 is equal to or smaller than 80°, the developing roller 20 is disposed (on a B1 side) away from directly above the rotation center P4 of the photosensitive drum 1a. This arrangement helps make the developing device 3a compact in the up-down direction (Z1-Z2). Furthermore, an open space exists above the photosensitive drum 1a in the Z1 direction, making it possible to secure an irradiation region for laser light C, which is irradiated from the scanning device 5, above the photosensitive drum 1a. Accordingly, it is possible to provide the developing device 3a that is capable of achieving excellent developer peeling performance while suppressing size increase, and the image forming apparatus 100 including the same.

The magnetic-flux-density peak-position of the peeling pole N3 faces the outer wall of the first conveyance chamber 22b. Note that the outer wall of the first conveyance chamber 22b surrounds the first spiral (first stirring conveyance member) 43, and includes the partition portion 22a. The magnetic-flux-density peak-position of the peeling pole N3, which is, in the present embodiment, positioned below the upper surface of the partition portion 22a in the Z2 direction, may instead be positioned above the upper surface of the partition portion 22a in the Z1 direction.

With such an arrangement, the removal (peeling-off) of the developer from the developing roller 20 is performed below the second spiral 44 inside the second conveyance chamber 22c. At this time, the developer having been removed from the developing roller 20 is collected into a position, inside the second conveyance chamber 22c, where the developer is loaded. Accordingly, it is possible to effectively suppress escaping of the toner through a gap between the developing roller 20 and the development container 22.

As viewed from the axial direction, an intersection point P6, at which a vertical line extending from the center P1 of the rotation shaft 43b of the first spiral (first stirring conveyance member) 43 perpendicularly intersects the line L1, is closer to the rotation center P3 of the developing sleeve 20a than an intersection point P5, at which a vertical line extending from the center P2 of the rotation shaft 44b of the second spiral (second stirring conveyance member) 44 perpendicularly intersects the line L1. By arranging the first spiral (first stirring conveyance member) 43 and the developing sleeve 20a close to each other in the horizontal direction (X1-X2), the developing device 3a can be made compact in the horizontal (X1-X2) direction.

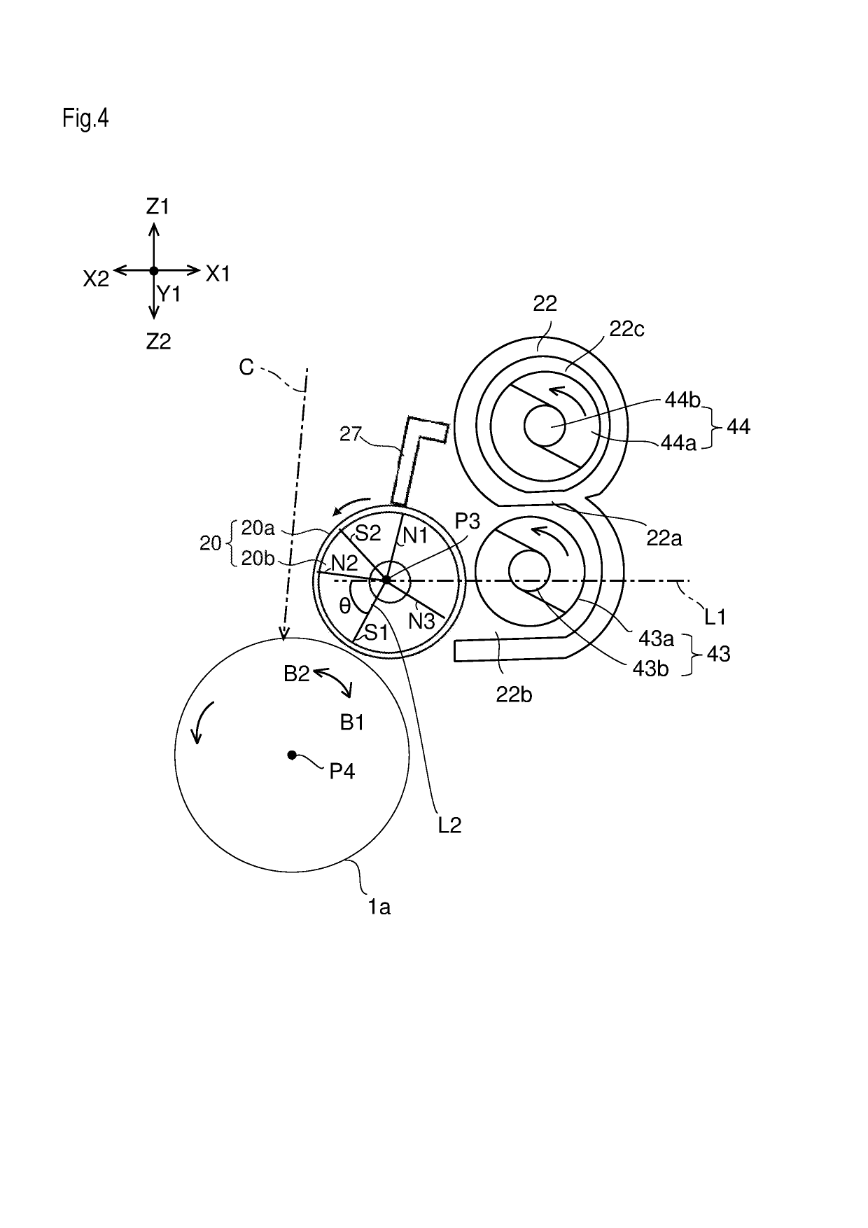

Additionally, it should be understood that the present disclosure may be practiced in any other manner than specifically described above as an embodiment, and various modifications are possible within the scope of the present disclosure. FIG. 4 is a vertical sectional view of a developing device 3a according to a modified example of the present embodiment. The supply and the collection of the developer to and from the developing roller (developer carrying member) 20, which are performed inside the second conveyance chamber 22c in the above-described embodiment, may be performed inside the first conveyance chamber 22b, instead. In that case, the developer is supplied from the first spiral 43 onto the developing roller 20. Further, it is preferable that the magnetic-flux-density peak-position of the peeling pole N3 face the outer wall of the first conveyance chamber 22b.

Furthermore, in the above-described embodiment, the regulation pole N1 is configured to have a wide magnetic pole width to function also as a pump-up pole, but instead, a separate pump-up pole may be provided on an upstream side of the regulation pole N1 with respect to a rotation direction of the developing roller 20. Moreover, in the above-described embodiment, the two conveyance poles N2 and S2 are provided, but instead, one conveyance pole or three or more conveyance poles may be provided.

The application of the present disclosure is not limited to intermediate transfer type color printers as shown in FIG. 1, but the present disclosure is also applicable to various types of image forming apparatuses provided with a developing device including a first conveyance chamber and a second conveyance chamber disposed above the first conveyance chamber, such as direct transfer type color printers, or monochrome copiers, color copiers, and facsimile machines using either digital or analog methods.

### INDUSTRIAL APPLICABILITY

The present disclosure is applicable to developing devices that include a first conveyance chamber and a second conveyance chamber disposed above the first conveyance chamber. By using the present disclosure, it is possible to provide a developing device capable of achieving satisfactory developer peeling performance while suppressing an increase in overall size, and an image forming apparatus including the same.

What is claimed is:

1. A developing device, comprising:
a development container that includes a first conveyance chamber and a second conveyance chamber disposed above the first conveyance chamber with a partition portion therebetween, and that holds therein a two-component developer including a carrier and toner.
a first stirring conveyance member that is rotatably supported inside the first conveyance chamber, and that conveys, while stirring, the developer inside the first conveyance chamber in a first direction;
a second stirring conveyance member that is rotatably supported inside the second conveyance chamber so as to be parallel to the first stirring conveyance member, and that conveys, while stirring, the developer inside the second conveyance chamber in a second direction that is a direction opposite to the first direction; and
a developer carrying member that is rotatably supported in the development container, and that carries, on a surface thereof, the developer inside the second conveyance chamber,
the developing device developing an electrostatic latent image having been formed on an image carrying member into a toner image,
wherein
the developer carrying member includes:
a developing sleeve that is rotatable and cylindrical in shape; and
a magnet member that is non-rotatably secured inside the developing sleeve, and that includes a plurality of magnetic poles arranged along a rotation direction of the developing sleeve,
the magnetic poles include:
a main pole that faces the image carrying member; and
a peeling pole that is disposed downstream of and adjacent to the main pole in the rotation direction of the developing sleeve, and that peels off the developer carried on the developer carrying member,
a magnetic-flux-density peak-position of the main pole is located below a horizontal line passing through a rotation center of the developing sleeve, and
as viewed from an axial direction, an angle that a line extending from the magnetic-flux-density peak-position of the main pole to the rotation center of the developing sleeve forms with respect to the horizontal line passing through the rotation center of the developing sleeve is 40° or larger but 80° or smaller.

2. The developing device according to claim 1,
wherein
the magnetic-flux-density peak-position of the peeling pole faces an outer wall of the first conveyance chamber.

3. The developing device according to claim 1,
wherein
as viewed from the axial direction, an intersection point at which a vertical line extending from a center of a rotation shaft of the first stirring conveyance member perpendicularly intersects the horizontal line passing through the rotation center of the developing sleeve is closer to the rotation center of the developing sleeve than an intersection point at which a vertical line extending from a center of a rotation shaft of the second stirring conveyance member perpendicularly intersects the horizontal line passing through the rotation center of the developing sleeve.

4. An image forming apparatus comprising the developing device according to claim 1.
